(19) United States
(12) Patent Application Publication
(10) Pub. No.: US 2008/0122618 A1
(43) Pub. Date: May 29, 2008

(54) Laser pool guard

(76) Inventors: Sandra Yvonne Courter, Gilbert, AZ (US); Jeramy Wilson Courter, Bloomington, MN (US)

Correspondence Address: SANDRA YVONNE COURTER, 319 W. OLIVE AVE., GILBERT, AZ, 85233, US

(21) Appl. No.: 11/975,246

(22) Filed: Oct. 19, 2007

Related U.S. Application Data
(60) Provisional application No. 60/867,683, filed on Nov. 29, 2006.

(51) Int. Cl. G08B 13/18; G08B 21/00; G08B 21/02

(52) U.S. Cl. 340/557; 340/541

(57) ABSTRACT

An alarm system designed to be armed at all times, and that never has to be manually reset, unless a small child or a pet crosses the bottom beam. Using a two beam system, one at the top of the gate or door, and one at or near the bottom, the system automatically knows when an appropriate height individual enters the area and resets itself. The system incorporates the ability to predetermine the height of individuals that will trigger alarm.

### CROSS-REFERENCE TO RELATED APPLICATION

The inventors claim pre-application date as applied to provisional patent application No. 60/867,683, Filing date; Nov. 29, 2006.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The Laser Pool Guard is designed to be a back up system to an already existing pool alarm system as an added measure to prevent small children and pets from going through a gate or doorway accidentally left open or disarmed by an older child or adult. When a pool is in use, most systems are usually turned off, thereby allowing for an opportunity for a small child to wander into the pool area unnoticed. This system will never be turned off. Therefore, if an older child or adult either forgets to turn an existing alarm back on or relock a gate and a small child or small pet gets through the gate or door, someone will be alerted.

This system utilizes a dual beam configuration. These two beams, one at the top and one at the bottom of pool entrance, are always on. When only the bottom beam is broken, it will cause the system to alarm. There is a 1.5 second delay to allow time for the top beam to be broken. If, within this time limit, the top beam is broken, the system will reset the alarm. If, however, the top beam is not broken within the 1.5 seconds, the system will alarm with an audible sound through a device such as a PIEZO alarm. The alarm can then be reset by breaking the top beam.

This invention has a system of sliding tracks incorporated into it, whereby allowing the person setting up the system to determine the height of an individual that will trigger the alarm. This will enable the user to decide the height of individuals appropriate to each household or entity.

This system is also designed to be armed during use of the pool. Therefore, persons of the correct height can pass back and forth through gate or door without sounding an alarm or being required to turn off the system. The system also has the application of guarding against a pet getting out of a yard or door or a small child opening an unlocked door and leaving without the notice of an adult.

### BRIEF SUMMARY OF INVENTION

Out of all the different pool alarm system currently on the market, there are none that can be armed during use of the pool. All other systems need to be turned off, unlocked or must manually be reset after alarm is triggered. Our invention fills this gap. The system is designed to be armed at all times, and never has to be manually reset unless a small child or a pet crosses the bottom beam. By using a two beam system, one at the top of the gate or door, and one at or near the bottom, the system automatically knows when an appropriate height individual enters the area and resets itself. Our invention also gives the owner the ability to determine just how tall a child must be, before he/she will not trigger the alarm by using the systems of tracks designed into the system. With the top beam units being mounted on a track at a height determined by owner of the pool, they can determine whether their can child enter the pool area without the alarm sounding.

### BRIEF DESCRIPTION OF THE DRAWINGS

FIG. 1 illustrates the external appearance of components involved in the basic embodiment of the Laser Pool Guard alarm.

FIG. 2 is a flowchart illustrating the concept behind the functionality of the Laser Pool Guard.

FIG. 3 illustrates the design of the Solar Power Emitter shown in FIG. 1, numbered 3, and 5.

FIG. 4 illustrates the design of the Control Box shown in FIG. 1, numbered 1.

FIG. 5 illustrates the design of the Bottom Laser Receiver shown in FIG. 1, numbered 6.

FIG. 6 illustrates the design of the Top Laser Receiver shown in FIG. 1, numbered 4.

FIG. 7 illustrates the possible design of the External PIEZO Alarm.

FIG. 8 illustrates one embodiment of the Laser Pool Guard alarm mounted on a Picket Fence.

FIG. 9 illustrates one embodiment of the Laser Pool Guard alarm mounted on a Chain Link Fence.

FIG. 10 illustrates one embodiment of the Laser Pool Guard alarm mounted on a Standard Door.

FIG. 11 illustrates one embodiment of the Laser Pool Guard alarm mounted on a Sliding or Double Door.

### DETAILED DESCRIPTION OF THE INVENTION

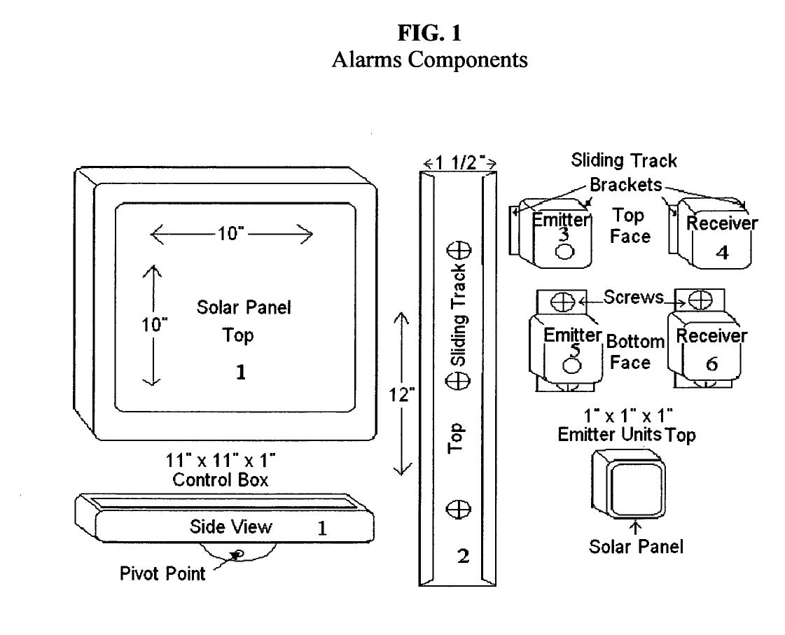

The individual components of the Laser Pool Guard alarm is shown in FIG. 1 and comprises a solar powered control box, 2 Infrared receivers hardwired into the control box, and 2 solar powered laser transmitters.

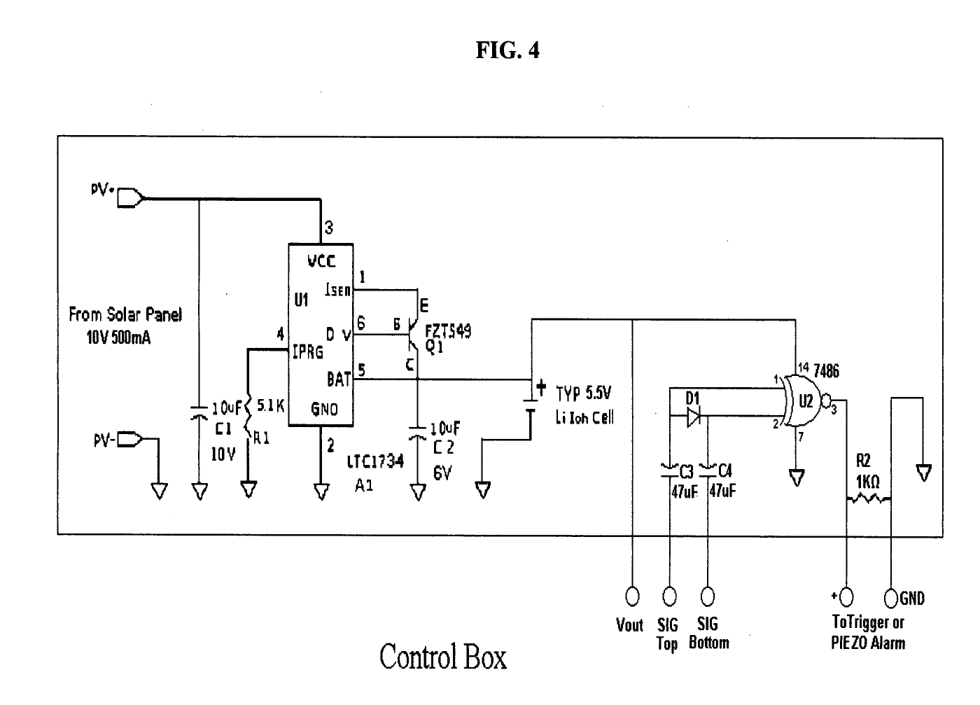

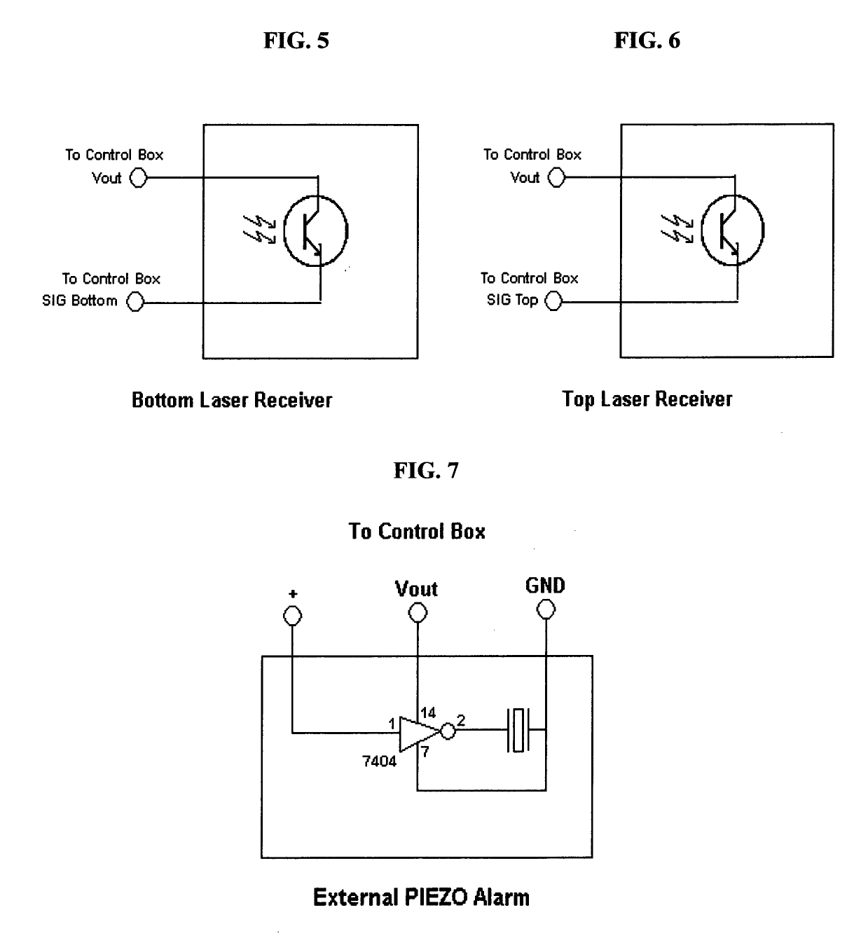

During installation, the two receivers, numbered 4 and 6, will be mounted on the same side of an entryway, hardwired to the control box, numbered 1, using the appropriate connections as illustrated in FIG. 4, FIG. 5, and FIG. 6. The two solar powered laser emitters, numbered 3 and 5, will be mounted on the opposite side of the entry way. The top solar powered laser emitter, numbered 3, and corresponding receiver, numbered 4, will be mounted on a track system, numbered 2, that will allow for them to be adjusted to a level determined by the owner of the Laser Pool Guard alarm. The control box, numbered 1, will be mounted on a pivot point so that it can be targeted to receive optimal light for the solar panel.

The housing of all components is preferably formed of a material that is substantially waterproof and resistant to weather conditions. Therefore, suitable plastics, composites, and metals are advantageously used because they do not absorb moisture and generally do not degrade when exposed to weather conditions. Furthermore, it is preferable to utilize materials that do not react when exposed to traditional pool chemicals, such as, for example, chlorine, bromine, and other cleaners.

The housing of all components is advantageously constructed such that that the openings formed therein are substantially watertight. The housings will contain electronics that are particularly sensitive to moisture. Therefore, it is advantageous that the housings are substantially watertight. This may be accomplished by providing a seal, such as a gasket, around the openings in the housings.

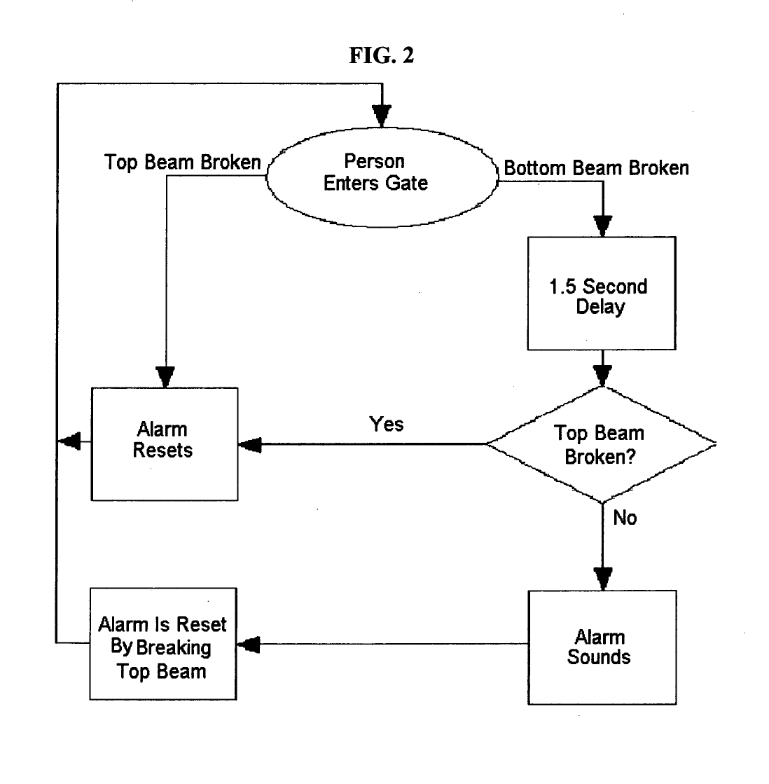

FIG. 2 illustrates the logic instructions of the circuitry contained within the Control Box. The circuitry sits and idly waits for a beam to be broken. When a broken beam is detected, the circuitry determines if the top or bottom beam was broken. If the top beam was broken, then the system automatically resets after 1.5 seconds. If the bottom beam is broken, the circuitry will initialize a 1.5 second delay to allow walking delay or for a parent walking behind a child to break the top beam. If the top beam is broken, the system resets after another 1.5 second delay, allowing for a child walking behind an adult to cross past the beam without the alarm sounding. If the top beam is not broken, the control box sends a signal to an external switch of some sort that will trigger a home security system or external siren. The siren signal will continue to send until the top beam is broken to reset the system back to its original state.

Thus, the logic circuit detects the access of a point of pool entry and then sounds the alarm unless certain criteria are met. Specifically, the alarm is sounded unless the top beam is broken and the alarm is reset. This is accomplished with the use of electronic logic circuits. Therefore, no software or computer programming is needed.

The result is a pool security system that protects a point of pool entry and alerts to both unauthorized entry by a child or pet. The system is continually powered by solar power and a rechargeable battery. Moreover, an optional external siren can be positioned to emit an audible signal.

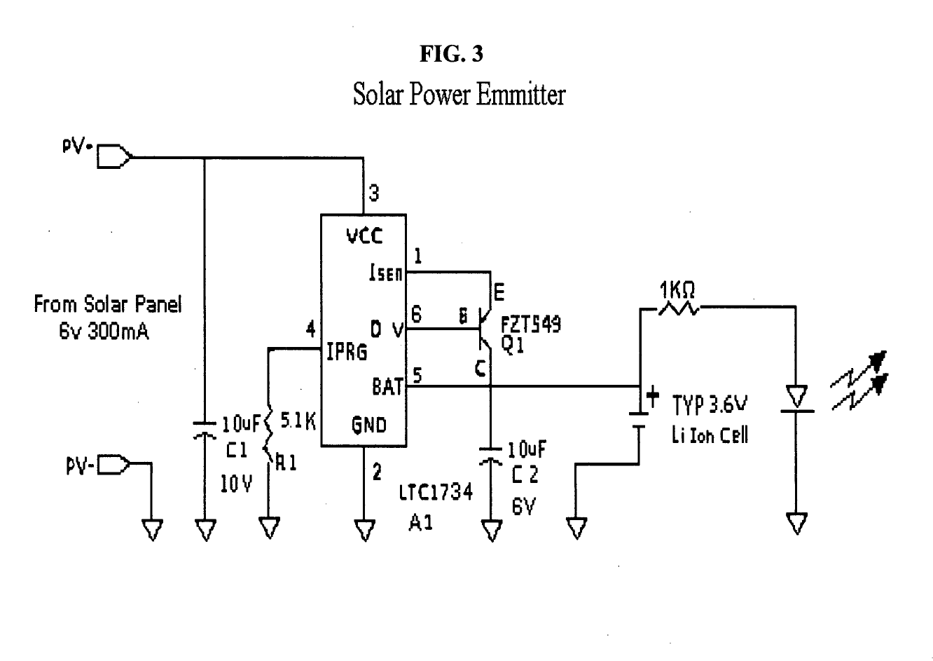

The Solar Powered Emitter shown in FIG. 3 is designed with solar power source, basic charging circuitry, and a battery, all running an infrared LED. The power source shown can ultimately be any DC power source of the required specifications shown. There are two identical Solar Powered Emitters in the basic embodiment.

The Control Box shown in FIG. 4 is designed with a solar power source, basic charging circuitry, and a battery, all running the logic circuitry. The power source shown can ultimately be any DC power source of the required specifications shown. The control box requires more power as it will also be powering the two infrared receivers, and possibly an external siren, or switch.

The Infrared Receivers shown in FIG. 5 and FIG. 6 are hard wired to the Control Box according to whether they are the top or the bottom receiver. The Control Box will be labeled with the appropriate connections, so as to identify which sensor to connect to which connections, determined by whether the sensor is on the top or bottom.

The PIEZO Alarm shown in FIG. 7 is shown as a possible external siren for this system. The signal coming into it from the control box will need to be inverted for a basic PEIZO buzzer as shown in FIG. 7.

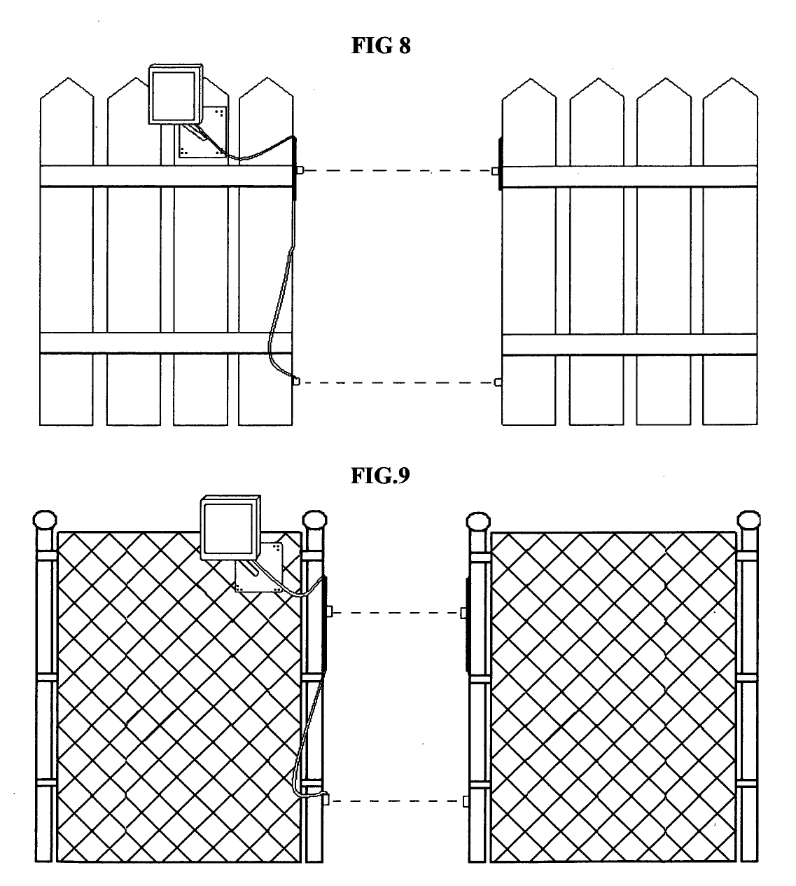

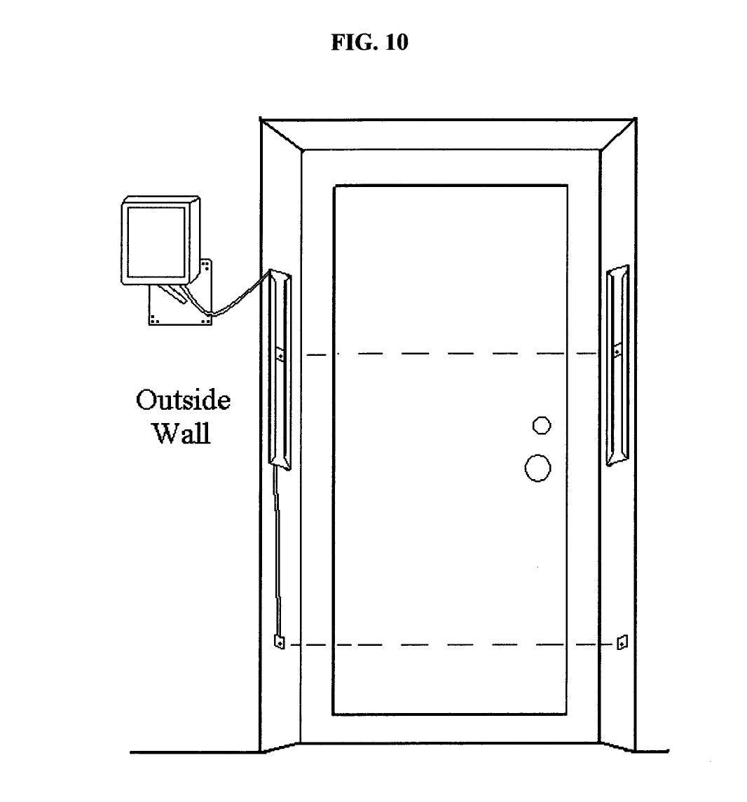

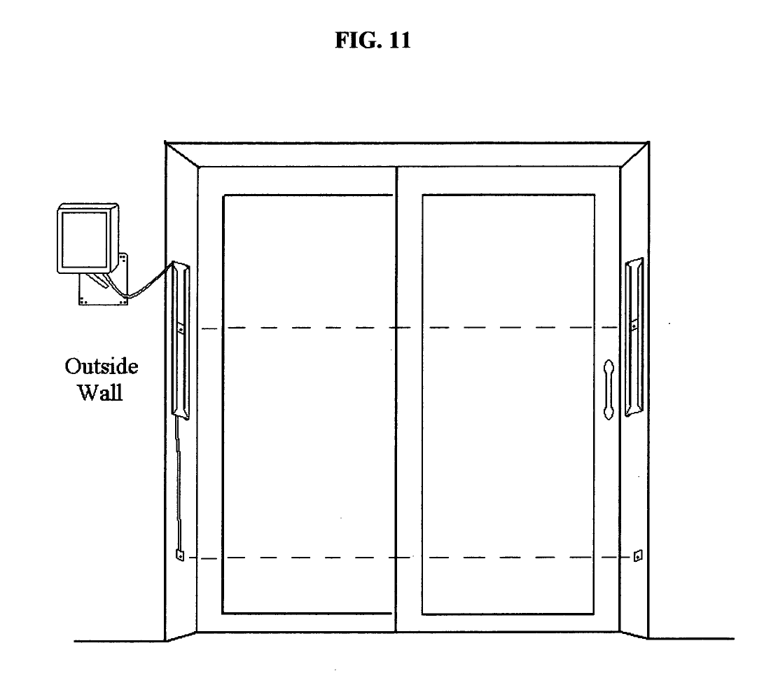

The embodiments illustrated in FIG. 8, FIG. 9, FIG. 10 and FIG. 11 are designed to guard a single point of pool entry and are used to guard a single door that leads to a pool area. A battery will be present as a backup power source in case power from the solar panel is not available or becomes interrupted. Thus, FIG. 8, FIG. 9, FIG. 10 and FIG. 11 illustrate an embodiment of a pool guard that is always actively monitoring a point of pool access, and does not require any maintenance or upkeep to continue the monitoring service.

Some swimming pool safety regulations require that security measures are constantly active. In response, many pool owners install locks that require a key for entering and/or exiting the pool area. However, keys are easily lost and inventory control can be difficult. Furthermore, gates or doors may be inadvertently left open after an authorized entrance into the pool area, thus allowing unauthorized entry, such as by unattended children.

An alarm constructed in accordance with the present invention overcomes these inherent disadvantages of key-operated locks by incorporating a set of two beams that constantly monitor the height of the person entering the pool and sounds an alarm if a pool entry point has been breached without the knowledge of a responsible adult.

In operation, as a point of pool entry is accessed without a responsible adult, the duality of sensors send signals to circuitry contained within the control unit that determines whether or not to sound an audible alarm according to preprogrammed logic instructions. For example, once an entry way is accessed, an entrant must have someone of specified appropriate height enter within 1.5 seconds or else the alarm is sounded to alert of unauthorized entry. The top beam is preferably positioned out of reach of smaller children so that they cannot reach the beam even if they know its function. As another example of the logic instructions, if the pool alarm is triggered, it will continue to sound until the top beam is broken to reset the system.

While the foregoing description has been limited to specific preferred embodiments, it should be appreciated that variations there from are anticipated without departing from the full spirit and scope of the present invention. Thus, while the invention has been described herein with reference to certain preferred embodiments, these embodiments have been presented by way of example only, and not to limit the scope of the invention. Accordingly, other embodiments and changes in form and detail may be made therein by one skilled in the art without departing from the spirit and scope of the invention, including embodiments which do not provide all of the benefits and features set forth herein.

What we claim as our invention is:

1. An alarm for securing a pool area, comprising: a plurality of sensors and receivers, configured to detect when a separate point of pool access has been breached without an adult or child of appropriate size; a delay timer operatively coupled to said sensor to prevent the alarm from triggering if both sensors are not broken at the same time; an audio emitter coupled to said sensors; a solar cell and a backup battery operatively may be coupled to said sensors, and audio emitter, for providing electrical power thereto; a housing configured to contain both the sensors and receivers of each said access point, and wherein said alarm is configured to detect the breach of each pool access point without the presence of an adult or child of appropriate size, and activate an audible signal.

2. The alarm according to claim 1, will not trigger if an adult or a child of appropriate size, set by putting one of the sensor sets on a track system allowing for a adjustable preset height set by owner, passes through the pool access.

3. The alarm according to claim 1, will be always on whether the pool is in use or not, with no need to disarm or reset at any time, unless a small child or a pet crosses the bottom beam.

4. The alarm according to claim 1, wherein said sensors comprise a laser and laser receiver, said laser sensor configured to detect the presence or absence of said laser.

5. The alarm according to claim 1, further comprising circuitry having mechanisms for receiving a signal from said sensor, activating said delay timer, and activating said audio emitter.

6. The alarm according to claim 1, can be reset by an adult or child of appropriate height simply by breaking the top beam.

7. The alarm according to claim 1, wherein said delay timer is configured to detect the passing of a predetermined amount of time.

8. The alarm according to claim 7, wherein said predetermined amount of time is about 1.5 seconds.

9. The alarm according to claim 1, wherein said housing is comprised of water resistant plastic and molding.

10. The alarm according to claim 1, wherein said plurality of sensors each send corresponding signals to a processing unit that will trigger an audio alarm.

11. The alarm according to claim 1, further comprising a siren coupled to said circuitry and configured to provide an audible signal.
